(19) United States
(12) Patent Application Publication
(10) Pub. No.: US 2026/0182671 A1
(43) Pub. Date: Jul. 2, 2026

(54) AEROSOL-GENERATING DEVICE WITH PUFF-PROMPTING MEANS

(71) Applicant: Philip Morris Products S.A., Neuchatel (CH)

(72) Inventors: Guillaume Bastien BAUR, Lausanne (CH); Mathias BEUTLER, Vallon (CH); Fabrice STEFFEN, Colombier (CH); Bruno Christian Joseph CHASSOT, Auvernier (CH); Alexandros Vassilios VASSILIOU, Muntelier (CH); Stéphane Martin Roland LAUTENBACHER, Neuchâtel (CH)

(73) Assignee: Philip Morris Products S.A., Neuchatel (CH)

(21) Appl. No.: 19/127,155

(22) PCT Filed: Nov. 16, 2023
(86) PCT No.: PCT/EP2023/082028

§ 371 Date: May 5, 2025

(30) Foreign Application Priority Data
Nov. 16, 2022 (EP) 22207688.7

(51) Int. Cl. A24F 40/60; A24F 40/50; H05B 1/02

(52) U.S. Cl. CPC A24F 40/60; A24F 40/50; H05B 1/0252

(57) ABSTRACT

An aerosol-generating device is provided, including: a heating element configured to heat an aerosol-forming substrate; a puff-prompting component; and a controller configured to control the puff-prompting component to generate a puff-prompting signal to a user, when the heating element has reached a predetermined preheating temperature during a preheating phase of the heating element, and generate the puff-prompting signal before the heating element reaches a final heating temperature at the end of the preheating phase.

The present invention relates to an aerosol-generating device. The present invention further relates to a system and a method.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device. Ambient conditions may influence the quality of the generated aerosol. Particularly high humidity conditions may lead to the aerosol-forming substrate having a high humidity. Particularly low humidity conditions may lead to the aerosol-forming substrate having a low humidity. Aerosol-forming substrate having a high humidity may lead to an “warm aerosol perception” effect when the vaporized humidity in the aerosol-forming substrate is inhaled during the first puff.

It would be desirable to have an aerosol-generating device with improved aerosol consistency. It would be desirable to have an aerosol-generating device for preventing the “warm aerosol” effect. It would be desirable to have an aerosol-generating device with reduced humidity in the first generated aerosol puff.

According to an embodiment of the invention there is provided an aerosol-generating device that may comprise a heating element configured to heat an aerosol-forming substrate. The aerosol-generating device may further comprise a puff-prompting means and a controller. The controller may be configured to control the puff-prompting means to generate a puff-prompting signal to a user, when the heating element has reached a predetermined preheating temperature during a preheating phase of the heating element.

According to an embodiment of the invention there is provided an aerosol-generating device comprising a heating element configured to heat an aerosol-forming substrate. The aerosol-generating device further comprises a puff-prompting means and a controller. The controller is configured to control the puff-prompting means to generate a puff-prompting signal to a user, when the heating element has reached a predetermined preheating temperature during a preheating phase of the heating element.

The aerosol-generating device may be configured to generate an optimal aerosol under specific conditions. More specifically, the aerosol-generating device may be configured to generate an optimal aerosol by heating the aerosol-forming substrate having a predefined moisture level. If the moisture level of the aerosol-forming substrate is higher than the predefined moisture level, the initial smoking experience may be less optimal. This problem may be overcome by providing the puff-prompting means generating the puff-prompting signal to a user at a predetermined preheating temperature of the heating element.

The puff-prompting means is preferably configured as a puff-prompting element.

During the preheating phase of the heating element, the temperature of the heating element may be increased to the desired final heating temperature. If, for example, the moisture level of the aerosol-forming substrate is higher than the predefined moisture level for which the aerosol-forming device is optimized, the first puff of a user may comprise a high level of vaporized water. This may be unpleasant. By providing the puff-prompting signal to the user during the preheating phase, the user may take a puff at this time during the preheating phase. The controller may be configured to control the puff-prompting means to generate the puff-prompting signal before the heating element reaches a final heating temperature at the end of the preheating phase. In other words, the term “during” may refer to a time before the end of the preheating phase. This puff may thus remove the excess moisture from the aerosol-forming substrate. Particularly, the excess moisture may be removed before the end of the preheating phase and before the heating element has reached its final heating temperature. Taking this puff during the preheating phase may prevent an unpleasant first puff of the user when the heating element has reached the final heating temperature, as only a limited amount of moisture will the vaporized at the time of the puff during the preheating phase when the heating element has reached the predetermined preheating temperature. In other words, the predetermined preheating temperature at which the puff-prompting means generates the puff-prompting signal is chosen such that potential excess moisture is removed from the aerosol-forming substrate by a user's puff at that time but an unpleasant first puff of the user is avoided when the heating element has reached the final heating temperature.

The puff-prompting means may comprise a vibration element. The puff-prompting means may be a vibration element.

The vibration element may be configured to generate a haptic signal as the puff-prompting signal to a user. The haptic signal may indicate to a user that the user should take a puff at that time to remove potential excess moisture from the aerosol-forming substrate during the preheating phase of the aerosol-generating device.

The vibration element may be arranged at or near the periphery of the aerosol-generating device. The user may thus experience the haptic feedback via the fingers holding the aerosol-generating device.

The puff-prompting means may comprise an acoustic element. The puff-prompting means may be an acoustic element.

The acoustic element may be configured to generate an acoustic signal as the puff-prompting signal to a user. The acoustic signal may indicate to a user that the user should take a puff at that time to remove potential excess moisture from the aerosol-forming substrate during the preheating phase of the aerosol-generating device.

The puff-prompting means may comprise an optical element. The puff-prompting means may be an optical element.

The optical element may be configured to generate an optical signal as the puff-prompting signal to a user. The optical signal may indicate to a user that the user should take a puff at that time to remove potential excess moisture from the aerosol-forming substrate during the preheating phase of the aerosol-generating device.

The predetermined preheating temperature may be between 110° C. and 180° C., preferably between 120° C. and 160° C., more preferably between 130° C. and 150° C., most preferably 140° C.

The aerosol-generating device may further comprise a temperature sensor. The temperature sensor may be configured to measure the temperature of the heating element. The controller may be configured to control the puff-prompting means based on the temperature sensor output.

Preferably, the controller may be configured to control the puff-prompting means to generate the puff-prompting signal, when the temperature sensor detects that the heating element has reached the predetermined preheating temperature.

The temperature sensor may be configured to measure the temperature of the heating element by measuring the electrical resistance of the heating element.

The preheating phase may start with the activation of the aerosol-generating device. The preheating phase may have a duration of below 60 seconds, preferably below 50 seconds, more preferably below 40 seconds, most preferably below 30 seconds.

The puff-prompting signal may be generated between 5 seconds and 30 seconds after the start of the preheating phase, preferably between 10 and 20 seconds after the start of the preheating phase.

A heating temperature of the heating element may be above 200° C., preferably above 220° C., more preferably above 230° C., more preferably above 235° C., most preferably around 235° C.

The controller may be configured to control the puff-prompting means to generate a puff-ready signal to a user when the heating element may have reached the heating temperature.

The puff-ready signal may signal the end of the preheating phase. The puff-ready signal may signal to a user that the initial puff can be taken and that the excess moisture has been removed from the aerosol-generating substrate by the puff during the preheating phase. The initial puff denotes the first puff of the desired smoking experience and excludes the initial puff during the preheating phase.

The puff-ready signal may be different from the puff-prompting signal such that a user can differentiate between the puff-prompting signal and the puff-ready signal. Exemplarily, if the puff-prompting signal is a haptic signal as described herein, the puff-ready signal may be a different haptic signal or may be an acoustic signal or may be an optical signal. If the puff-prompting signal is an acoustic signal as described herein, the puff-ready signal may be a different acoustic signal or may be a haptic signal or may be an optical signal. If the puff-prompting signal is an optical signal as described herein, the puff-ready signal may be a different optical signal or may be a haptic signal or may be an acoustic signal.

The puff-prompting signal may comprise one or more of: a vibration signal, a haptic signal, an acoustic signal, and an optical signal.

The invention further relates to an aerosol-generating system comprising the aerosol-generating device as described herein and an aerosol-generating article comprising aerosol-forming substrate.

The invention further relates to a method for removing excess moisture from an aerosol-forming substrate in an aerosol-generating device as described herein. The method may comprise:
controlling, via the controller, the puff-prompting means to generate a puff-prompting signal to a user, when the heating element may have reached a predetermined preheating temperature during a preheating phase of the heating element.

As used herein, the terms ‘proximal’, ‘distal’, ‘downstream’ and ‘upstream’ are used to describe the relative positions of components, or portions of components, of the aerosol-generating device in relation to the direction in which a user draws on the aerosol-generating device during use thereof.

The aerosol-generating device may comprise a mouth end through which in use an aerosol exits the aerosol-generating device and is delivered to a user. The mouth end may also be referred to as the proximal end. In use, a user draws on the proximal or mouth end of the aerosol-generating device in order to inhale an aerosol generated by the aerosol-generating device. Alternatively, a user may directly draw on an aerosol-generating article inserted into an opening at the proximal end of the aerosol-generating device. The opening at the proximal end may be an opening of the cavity. The cavity may be configured to receive the aerosol-generating article. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be upstream or downstream of one another based on their relative positions between the proximal, downstream or mouth end and the distal or upstream end of the aerosol-generating device.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber, and a heating element.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold-and iron-containing alloys, and super-alloys based on nickel, iron, cobalt, stainless steel, Timetal® and iron-manganese-aluminium based alloys. In composite materials, the electrically resistive material may optionally be embedded in, encapsulated, or coated with an insulating material or vice-versa, depending on the kinetics of energy transfer and the external physicochemical properties required.

As described, in any of the aspects of the disclosure, the heating element may be part of an aerosol-generating device. The aerosol-generating device may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

As an alternative to an electrically resistive heating element, the heating element may be configured as an induction heating element. The induction heating element may comprise an induction coil and a susceptor. In general, a susceptor is a material that can generate heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

As used herein, the term ‘aerosol-generating article’ refers to an article comprising an aerosol-forming substrate that can release volatile compounds that can form an aerosol. For example, an aerosol-generating article may be a smoking article that generates an aerosol that is directly inhalable into a user's lungs through the user's mouth. An aerosol-generating article may be disposable.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

Features described in relation to one embodiment may equally be applied to other embodiments of the invention.

The invention will be further described, by way of example only, with reference to the accompanying drawings in which:

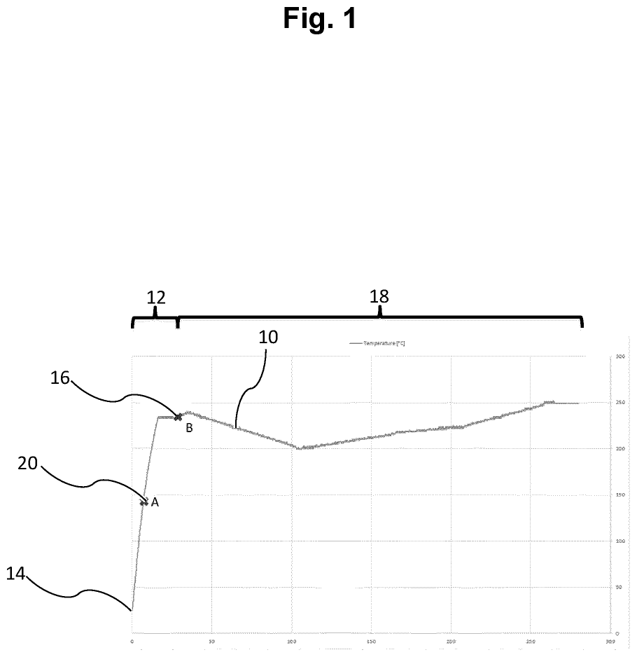

FIG. 1 shows a heating profile of the aerosol-generating device showing the heating temperature of the heating element over time during a preheating phase and during the subsequent smoking phase; and

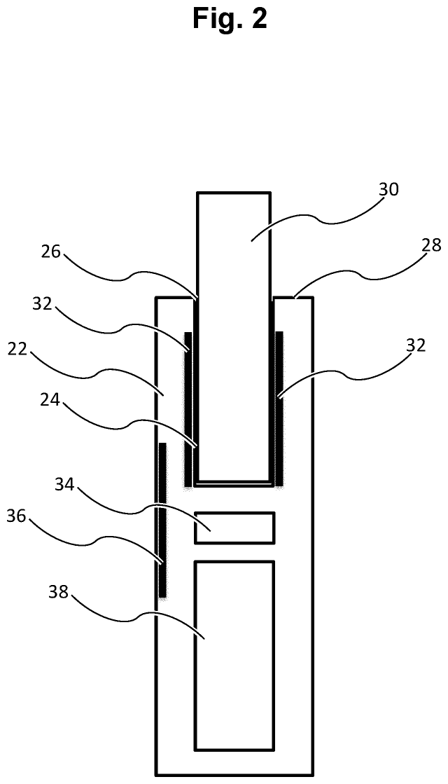

FIG. 2 shows the aerosol-generating device.

FIG. 1 shows a heating profile of a heating element 32 of an aerosol-generating device 22 (the device is shown in more detail with reference to below FIG. 2). The heating temperature 10 (in degrees centigrade—on the ordinate) of the heating element 32 of the aerosol-generating device 22 is shown over time (in seconds—on the abscissa). Initially, a preheating phase 12 of the aerosol-generating device 22 is shown in which the temperature of the heating element 32 increases from an initial temperature 14 (ambient temperature of the surrounding environment) to the final operating temperature 16 (also denoted by point “B” in FIG. 1) of around 240° C. The final operating temperature 16 is reached at the start of a smoking phase 18.

Between the initial temperature 14 and the final operating temperature 16 of the heating element 32, the heating element 32 will reach a predetermined preheating temperature 20 (also denoted by point “A” in FIG. 1). When the heating element 32 reaches the predetermined preheating temperature 20, the aerosol-generating device 22 generates a puff-prompting signal to a user via a puff-generating element. The user can then take an initial puff at this predetermined preheating temperature 20 of the heating element 32 to remove potential excess moisture from the aerosol-forming substrate. The excess moisture will have been vaporized at the predetermined preheating temperature 20 of the heating element 32, as the predetermined preheating temperature 20 is around 140° C.

FIG. 2 shows the aerosol-generating device 22 having a cavity 24 configured as a heating chamber with an opening 26 at a proximal end 28 of the aerosol-generating device 22. The cavity 24 is configured to receive an aerosol-generating article 30 comprising aerosol-forming substrate. The aerosol-forming substrate of the aerosol-generating article 30 is heated by a heating element 32 arranged at least partly surrounding the cavity 24.

The aerosol-generating device 22 further comprises a temperature sensor (not shown) configured to determine the temperature of the heating element 32 by measuring the electrical resistance of the heating element 32. The temperature sensor may be integrated in a controller 34. The electrical resistance of the heating element 32 changes with the temperature of the heating element 32 such that measuring the electrical resistance of the heating element 32 is indicative of the temperature of the heating element 32. The output of the temperature sensor is received by the controller 34 which is further configured to control the operation of a puff-prompting means 36. The puff-prompting means 36 may be configured as a vibrating element, an acoustic element or an optical element configured to generate a puff-prompting signal to a user.

The puff-prompting means 36, the controller 34 and the heating element 32 are powered by a power supply 38 in the form of a battery.

The puff-prompting means 36 is controlled by the controller 34 to generate a puff-prompting signal when the heating element 32 has reached the predetermined preheating temperature 20 during the preheating phase 12 of the aerosol-generating device 22. The puff-prompting signal indicates to the user that a puff should be taken during this time of the preheating phase 12 of the aerosol-generating device 22 such that potential excessive moisture can be removed from the aerosol-forming substrate by this puff without the vaporized moisture being too warm leading to an unpleasant puff.

Subsequently, the final operating temperature 16 of the heating element 32 is reached and the desired smoking phase 18 can begin. The heating element 32 reaching the final operating temperature 16 may be indicated by the puff-prompting means 36 by issuing a puff-ready signal. The puff-ready signal is different from the puff-prompting signal. In the smoking phase 18, the first puff of the user will have an optimal aerosol inhalation experience, as the excessive moisture from the aerosol-forming substrate has been removed and the heating element 32 can thus optimally generate an aerosol from the aerosol-forming substrate.

1.-15. (canceled)

16. An aerosol-generating device, comprising:
a heating element configured to heat an aerosol-forming substrate;
a puff-prompting means; and
a controller configured to control the puff-prompting means to
generate a puff-prompting signal to a user, when the heating element has reached a predetermined preheating temperature during a preheating phase of the heating element, and
generate the puff-prompting signal before the heating element reaches a final heating temperature at the end of the preheating phase.

17. The aerosol-generating device according to claim 16, wherein the puff-prompting means comprises a vibration element.

18. The aerosol-generating device according to claim 16, wherein the puff-prompting means comprises an acoustic element.

19. The aerosol-generating device according to claim 16, wherein the puff-prompting means comprises an optical element.

20. The aerosol-generating device according to claim 16, wherein the predetermined preheating temperature is between 110° C. and 180° C.

21. The aerosol-generating device according to claim 16,
further comprising a temperature sensor configured to measure a temperature of the heating element,
wherein the controller is further configured to control the puff-prompting means based on the temperature sensor output.

22. The aerosol-generating device according to claim 21, wherein the temperature sensor is further configured to measure the temperature of the heating element by measuring an electrical resistance of the heating element.

23. The aerosol-generating device according to claim 16, wherein the preheating phase starts with activation of the aerosol-generating device.

24. The aerosol-generating device according to claim 16, wherein the preheating phase has a duration of below 60 seconds.

25. The aerosol-generating device according to claim 16, wherein the puff-prompting signal is generated between 5 seconds and 30 seconds after a start of the preheating phase.

26. The aerosol-generating device according to claim 16, wherein a heating temperature of the heating element is above 200° C.

27. The aerosol-generating device according to claim 26, wherein the controller is further configured to control the puff-prompting means to generate a puff-ready signal to a user when the heating element has reached the heating temperature.

28. The aerosol-generating device according to claim 16, wherein the puff-prompting signal comprises one or more of: a vibration signal, a haptic signal, an acoustic signal, and an optical signal.

29. An aerosol-generating system comprising the aerosol-generating device according to claim 16 and an aerosol-generating article comprising aerosol-forming substrate.

30. A method for removing excess moisture from an aerosol-forming substrate in an aerosol-generating device according to claim 16, the method comprising:
controlling, via the controller, the puff-prompting means to generate a puff-prompting signal to a user, when the heating element has reached a predetermined preheating temperature during a preheating phase of the heating element; and
controlling, via the controller, the puff-prompting means to generate the puff-prompting signal before the heating element reaches a final heating temperature at the end of the preheating phase.
